(19) United States
(12) Patent Application Publication
(10) Pub. No.: US 2024/0339040 A1
(43) Pub. Date: Oct. 10, 2024

(54) AUTO-GENERATION OF AUGMENTED REALITY TUTORIALS FOR OPERATING DIGITAL INSTRUMENTS THROUGH RECORDING EMBODIED DEMONSTRATION

(71) Applicant: Purdue Research Foundation, West Lafayette, IN (US)

(72) Inventors: Karthik Ramani, West Lafayette, IN (US); Zhengzhe Zhu, West Lafayette, IN (US); Ziyi Liu, Delaware, OH (US)

(21) Appl. No.: 18/615,083

(22) Filed: Mar. 25, 2024

Related U.S. Application Data
(60) Provisional application No. 63/494,267, filed on Apr. 5, 2023.

(51) Int. Cl. G09B 5/02; G06F 3/01; G06T 7/20; G06T 7/70

(52) U.S. Cl. CPC G09B 5/02; G06F 3/014; G06T 7/20; G06T 7/70; G06T 2200/24; G06T 2207/30196

(57) ABSTRACT

A digital instrument tutorial system is introduced herein, which enables the authoring and provision of augmented reality (AR) tutorials for operating digital instruments. The digital instrument tutorial system provides an automated authoring workflow for users (e.g., an expert user and/or author) to create sequential AR tutorials for digital instruments by intuitive embodied demonstration. The digital instrument tutorial system advantageously utilizes a multimodal approach that combines finger pressure and gesture tracking to translate the author's operations into AR visualizations. Aside from recording a tutorial for a task, the digital instrument tutorial system also provides an access mode, in which the AR tutorial is provided to a novice user.

This application claims the benefit of priority of U.S. provisional application Ser. No. 63/494,267, filed on Apr. 5, 2023 the disclosure of which is herein incorporated by reference in its entirety.

### GOVERNMENT LICENSE RIGHTS

This invention was made with government support under contract number DUE1839971 awarded by the National Science Foundation. The government has certain rights in the invention.

### FIELD

The system and method disclosed in this document relate to augmented reality and, more particularly, to auto-generation of augmented reality tutorials for operating digital instruments.

### BACKGROUND

Unless otherwise indicated herein, the materials described in this section are not admitted to be the prior art by inclusion in this section.

Digital instruments, such as home appliances, office and laboratory equipment, and recreational devices, are now interwoven into the fabric of our society. Most of these instruments feature a control panel populated with physical user interface elements (e.g., buttons, knobs), which serve as a gateway for the user's operation of the digital instrument. Traditionally, image or video tutorials are created to guide users through operation of the digital instrument. Recently, however, augmented reality (AR) tutorials have emerged as a preferable alternative to traditional image and video tutorials, where visual guidance is displayed directly on the associated digital instrument and thus is always within the user's line of sight. This reduces the user's cognitive load by removing the need to switch context and attention between the digital instrument and the external tutorial information.

The diversity of digital instruments and their associated operations has motivated researchers to empower end-users to author sequential AR tutorials on demand and in-situ. To this end, prior works have adopted the immersive programming paradigm to replace traditional 2D programming, in which users create AR tutorial guidance by manually selecting, placing, and manipulating virtual objects (e.g., menus, widgets, toolsets). For instance, a user might drag an arrow from a virtual library and rotate it to point down at a button. The challenge of this authoring process is that, for each step of the tutorial, the placement and scale of the AR visualizations must be properly and manually adjusted by the author. Otherwise, any misplaced (e.g., an arrow pointing to the wrong button) or improperly sized (e.g., an arrow not that is long enough to indicate where the slider should be pushed to) visualizations would undermine the effectiveness of the tutorials. This extra workload may cause strain on authors who have to switch their attention back-and-forth between operating the physical instrument and manipulating virtual objects. This issue is exacerbated when an operational task includes multiple steps (e.g., using an oscilloscope to measure current).

The key to achieving authoring by demonstration is finding the proper technique to reliably track the manipulated objects to transfer them into the virtual world. To this end, some prior works focus on assembly tasks and utilize overhead cameras to track the movement of manipulated objects and then generated their trajectories accordingly as visual guidance. However, physical user interface elements on digital instruments are much smaller compared to the objects involved in most assembly tasks, which makes the object tracking more susceptible to hand occlusion during manipulation.

What is needed is a system and method for authoring AR tutorials that does not require the author to manually design and manipulate the AR visualizations of the AR tutorial, and which overcomes the issues with occlusion of the physical user interface elements during demonstration and during the provision of the AR tutorial to novice users.

### SUMMARY

A method for authoring an augmented reality tutorial for operating a device is disclosed. The method comprises recording, with at least one sensor, interactions of a person with physical user interface elements of the device as the person demonstrates a first operation of the device. The method further comprises determining, with a processor, based on the recorded interactions, (i) a first type of physical user interface element that was interacted with, (ii) a first location on the device at which the first type of physical user interface element was interacted with, and (iii) the first operation that was performed. The method further comprises displaying, on a display in an augmented reality graphical user interface, graphical tutorial elements including a first graphical tutorial element superimposed at the first location on the device and indicating the first type of physical user interface element that was interacted with and the first operation that was performed.

A method for providing an augmented reality tutorial for operating a device is disclosed. The method comprises storing, in a memory, tutorial data indicating (i) a first type of physical user interface element that is to be interacted with, (ii) a first location on the device at which the first type of physical user interface element is to be interacted with, and (iii) a first operation that is to be performed. The method further comprises displaying, on a display in an augmented reality graphical user interface, graphical tutorial elements including a first graphical tutorial element superimposed at the first location on the device and indicating the first type of physical user interface element that is to be interacted with and the first operation that is to be performed. The method further comprises recording, with at least one sensor, interactions of a person with physical user interface elements of the device. The method further comprises determining, with a processor, based on the recorded interactions, (i) whether the person has interacted with the first type of physical user interface element at the first location on the device and (ii) whether the person has performed the first operation.

### BRIEF DESCRIPTION OF THE DRAWINGS

The foregoing aspects and other features of the system and method are explained in the following description, taken in connection with the accompanying drawings.

FIG. 1A summarizes an overall workflow for authoring an AR tutorial using a digital instrument tutorial system.

FIG. 1B summarizes an overall workflow for providing a previously authored AR tutorial using the digital instrument tutorial system.

FIG. 2 shows exemplary components of an AR system of the digital instrument tutorial system.

FIG. 3A shows one exemplary embodiment of a hand wearable controller.

FIG. 3B shows finger caps of the hand wearable controller in greater detail.

FIG. 4 shows a logical flow diagram for a method for authoring an AR tutorial for operating a digital instrument.

FIG. 5 shows an initial setup process with respect to an exemplary digital instrument.

FIG. 6 shows a taxonomy for gestures associated with each operation, as well as the hand joints that are tracked by the digital instrument tutorial system.

FIG. 7 shows a decision-tree-based algorithm for classifying interactions with user interface elements of the digital instrument.

FIG. 8 shows measurement behaviors of the pressure sensors of the hand wearable controller.

FIG. 9 shows a workflow for demonstrating a discrete operation with respect to a user interface element.

FIG. 10 shows a workflow for demonstrating a continuous operation with respect to a user interface element.

FIG. 11 shows automatically generated AR content for a variety of different user interface operations, and user adjustment of the generated AR content.

FIG. 12 shows processes for capturing additional AR tutorial content.

FIG. 13 shows a logical flow diagram for a method for providing an AR tutorial for operating a digital instrument.

FIG. 14 shows how a preemptive warning is provided when providing an AR tutorial.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

A digital instrument tutorial system 100 is introduced herein, which enables the authoring and provision of augmented reality (AR) tutorials for operating digital instruments. The digital instrument tutorial system 100 provides an automated authoring workflow for users (e.g., an expert user and/or author) to create sequential AR tutorials for digital instruments by intuitive embodied demonstration. The digital instrument tutorial system 100 advantageously utilizes a multimodal approach that combines finger pressure and gesture tracking to translate the author's operations into AR visualizations. Aside from recording a tutorial for a task, the digital instrument tutorial system 100 also provides an access mode, in which the AR tutorial is provided to a novice user.

As used herein, a “digital instrument” refers to any machine or other device having physical user interface elements that are interacted with by a person to perform a task. Such physical user interface elements may include buttons, knobs, dials, switches, toggles, sliders, and touch screens. Moreover, it should be appreciated that the term “digital instrument” may include instruments that are entirely analog in their operation and not, strictly-speaking, “digital.”

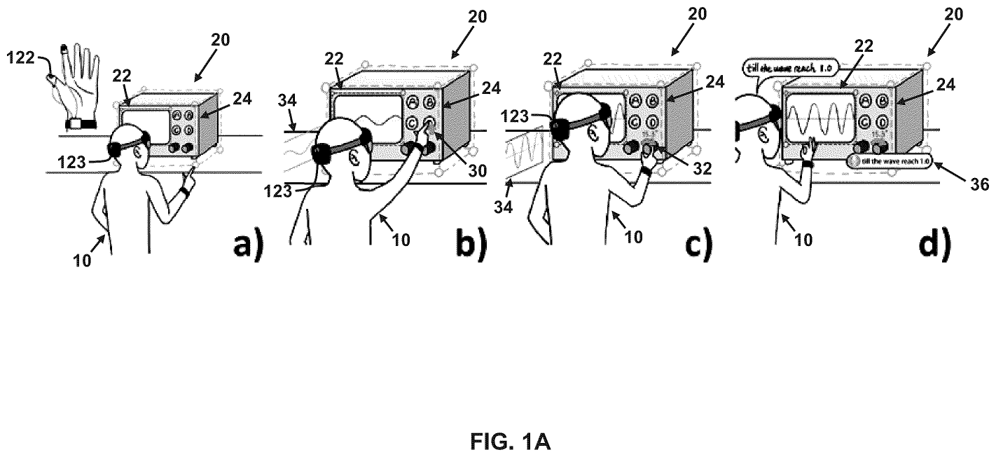

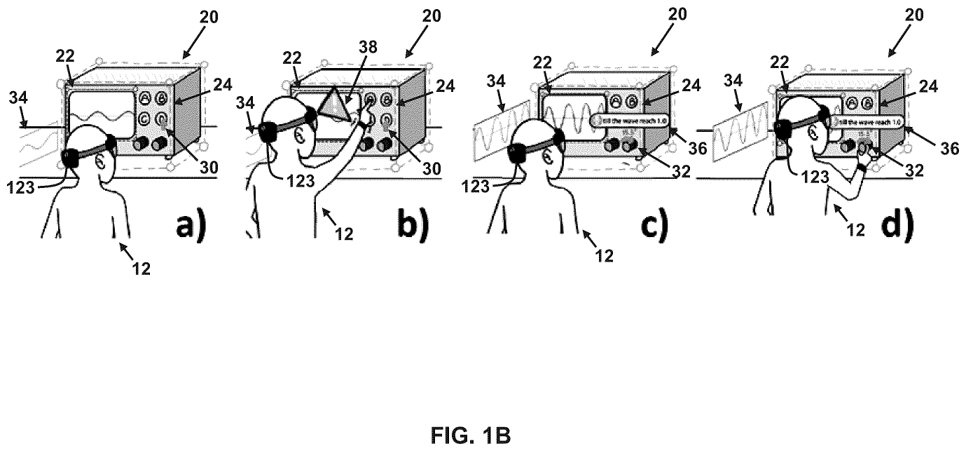

FIG. 1A summarizes an overall workflow for authoring an AR tutorial using the digital instrument tutorial system 100. The digital instrument tutorial system 100 advantageously enables an expert user 10 to automatically generate an AR tutorial by directly detecting and recording the expert user's embodied demonstration and operation with respect to elements of a physical user interface 24 of a digital instrument 20. To this end, an expert user 10 wears an AR head-mounted display (AR-HMD) 123 and a hand wearable controller 122, which enable the digital instrument tutorial system 100 to monitor interactions and/or operations of the expert user 10 with the digital instrument 20.

First, as shown in illustration a) of FIG. 1A, in an initial setup, the expert user 10 defines an interaction area that encompasses the digital instrument 20. Additionally, the expert user 10 defines an image capture area around a display screen 22 of the digital instrument 20. Next, the expert user 10 proceeds to demonstrate operating the digital instrument 20 in a step-by-step manner to perform a task. As shown in illustration b) of FIG. 1A, the expert user 10 presses a button of the physical user interface 24, which is considered a discrete operation. Similarly, as shown in illustration c) of FIG. 1A, the expert user 10 turns a knob of the physical user interface 24, which is considered a continuous operation. Finally, as shown in illustration d) of FIG. 1A, the expert user 10 records spoken voice instructions (e.g., “till the wave reach 1.0”).

As the expert user 10 demonstrates operating the digital instrument 20 in a step-by-step manner to perform a task, the digital instrument tutorial system 100 automatically generates AR visualizations that represent each interaction and/or operation demonstrated by the expert user 10. As shown in illustration b) of FIG. 1A, a virtual arrow 30 is generated to represent the interaction with the button of the physical user interface 24. As shown in illustration c) of FIG. 1A, a virtual arrow 32 with associated text (e.g., “15.3°”) is generated to represent the interaction with the knob of the physical user interface 24. In addition, after each step of the task, the system 100 automatically captures an image of the previously specified image capture area (i.e., an image of the display 22). This captured image is displayed as a virtual image 34 floating next to the digital instrument 20, as shown in illustrations b) and c) of FIG. 1A. Finally, the spoken voice instructions are automatically converted in to text and displayed as virtual text 36 (e.g., “till the wave reach 1.0”) floating next to the digital instrument 20, as shown in illustration d) of FIG. 1A.

FIG. 1B summarizes an overall workflow for providing a previously authored AR tutorial using the digital instrument tutorial system 100. The digital instrument tutorial system 100 provides an access mode, in which the AR tutorial is displayed to a novice user. The access mode incorporates an automatic feedback mechanism that can determine whether the system 100 should proceed to the next step or issue a visual-haptic warning based on the novice user's real-time operation of the digital instrument 20. To this end, a novice user 12 wears the AR-HMD 123 and the hand wearable controller 122, which enable the digital instrument tutorial system 100 to monitor interactions and/or operations of the novice user 12 with the digital instrument 20 as he or she experiences the AR tutorial.

First, as shown in illustration a) of FIG. 1B, the user starts by importing the previously authored AR tutorials, which can be accomplished with a single click if the digital instrument 20 has remained stationary. If not, the novice user 12 can utilize a fiducial marker to realign the visualizations of the AR tutorials. As the novice user 12 operates the digital instrument 20 to perform the task, the digital instrument tutorial system 100 will automatically proceed to the next step once it detects that the novice user 12 has performed the correct operation. However, as shown in illustration b) of FIG. 1B, if the novice user 12 places his or her hand on the wrong button, the digital instrument tutorial system 100 will immediately and preemptively issue a visual-haptic warning 38 or other perceptible feedback, which can prevent the user from making mistakes. Conversely, as shown in illustration c) of FIG. 1B, after the novice user 12 presses the correct button and the digital instrument tutorial system 100 automatically displays the instruction of the next step. Finally, as shown in illustration d) of FIG. 1B, the novice user 12 performs further operations with respect to the digital instrument 20 until the task is complete.

The predominance of digital instruments is a hallmark of the modern world. It should be appreciated that there are limitless possible application scenarios in which the ability of the digital instrument tutorial system 100 to generate AR tutorials automatically could be useful.

As an example, lab manuals for lab equipment might be provided in the form of AR tutorials. Particularly, experiments conducted in laboratories frequently require the operation of one or more digital instruments, such as an oscilloscope, a centrifuge, or a laser cutter, and previous research has demonstrated the need for instructors to create tutorials in a more effective and efficient manner.

As a further example, AR tutorials might be provided for the purpose of workforce training. Particularly, organizations all over the world have been searching for more efficient means of training their employees. With the digital instrument tutorial system 100, organizations can easily create AR training manuals to familiarize employees with the use of digital instruments used in the course of their employment. For example, factories could train workers on how to operate new models of CNC machines. Likewise, airlines could train pilots on how to operate control panels of new models of aircraft.

As yet another example, operation manuals for everyday home appliances and consumer devices might be provided in the form of AR tutorials. Particularly, the instruments used by common people on a daily basis could also benefit from easily generated AR tutorials. Examples of these instruments include coffee machines, printers, and music pads. These AR manuals can be generated not only by manufacturers but also by users themselves. While referring to the paper/video-based manuals, users could perform operations on the instrument and the corresponding AR tutorials will be generated in the meantime. These AR tutorials are displayed directly on the instrument and thus always in a readily accessible manner. Therefore, users do not need to retrieve the tutorial from elsewhere whenever they forget about the operation, which is more convenient.

### Exemplary Hardware and Software Components

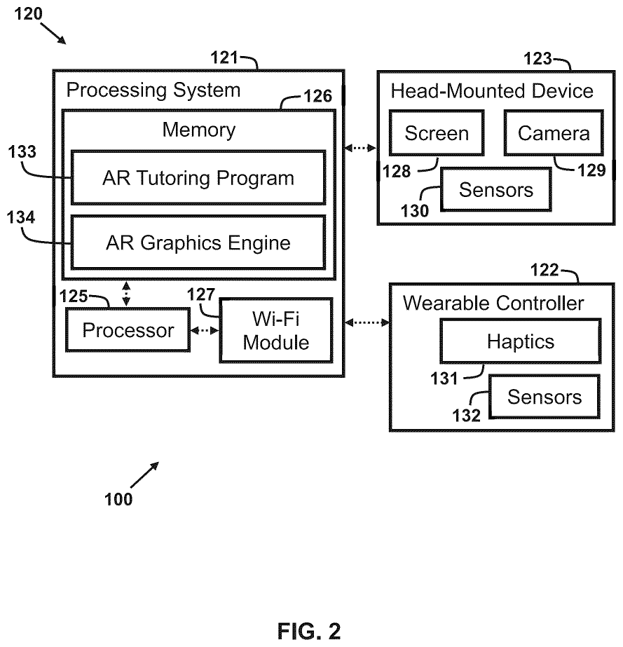

FIG. 2 shows exemplary components of an AR system 120 of the digital instrument tutorial system 100. It will be appreciated that the components of the AR system 120 shown and described are merely exemplary and that the AR system 120 may comprise any alternative configuration. Moreover, in the illustration of FIG. 2, only a single AR system 120 is shown. However, in practice, the digital instrument tutorial system 100 may include one or multiple AR systems 20.

To enable the AR tutorial environment, the digital instrument tutorial system 100 at least includes the AR system 120, at least part of which is worn or held by a user. The AR system 120 preferably includes the AR-HMD 123 having at least a camera and a display screen, but may include any mobile AR device, such as, but not limited to, a smartphone, a tablet computer, a handheld camera, or the like having a display screen and a camera. In one example, the AR-HMD 123 is in the form of an AR or virtual reality headset (e.g., Microsoft's HoloLens, Oculus Rift, or Oculus Quest) or equivalent AR glasses having an integrated or attached camera 129.

In the illustrated exemplary embodiment, the AR system 120 includes a processing system 121, the AR-HMD 123, the at least one hand wearable controller 122, and (optionally) external sensors (not shown). In some embodiments, the processing system 121 may comprise a discrete computer that is configured to communicate with the AR-HMD 123 via one or more wired or wireless connections. In some embodiments, the processing system 121 takes the form of a backpack computer connected to the AR-HMD 123. However, in alternative embodiments, the processing system 121 is integrated with the AR-HMD 123. Moreover, the processing system 121 may incorporate server-side cloud processing systems.

As shown in FIG. 2, the processing system 121 comprises a processor 125 and a memory 126. The memory 126 is configured to store data and program instructions that, when executed by the processor 125, enable the AR system 120 to perform various operations described herein. The memory 126 may be of any type of device capable of storing information accessible by the processor 125, such as a memory card, ROM, RAM, hard drives, discs, flash memory, or any of various other computer-readable media serving as data storage devices, as will be recognized by those of ordinary skill in the art. Additionally, it will be recognized by those of ordinary skill in the art that a “processor” includes any hardware system, hardware mechanism or hardware component that processes data, signals or other information. The processor 125 may include a system with a central processing unit, graphics processing units, multiple processing units, dedicated circuitry for achieving functionality, programmable logic, or other processing systems.

The processing system 121 further comprises one or more transceivers, modems, or other communication devices configured to enable communications with various other devices. Particularly, in the illustrated embodiment, the processing system 121 comprises a Wi-Fi module 127. The Wi-Fi module 127 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. As discussed in further detail below, the processor 125 is configured to operate the Wi-Fi module 127 to send and receive messages, such as control and data messages, to and from other devices via the Wi-Fi network and/or Wi-Fi router. It will be appreciated, however, that other communication technologies, such as Bluetooth, Z-Wave, Zigbee, or any other radio frequency-based communication technology can be used to enable data communications between devices in the system 100.

In the illustrated exemplary embodiment, the AR-HMD 123 a display screen 128 and a camera 129. The camera 129 is configured to capture a plurality of images of the environment as the AR-HMD 123 is moved through the environment by the user. The camera 129 is configured to generate image frames of the environment, each of which comprises a two-dimensional array of pixels. Each pixel at least has corresponding photometric information (intensity, color, and/or brightness). In some embodiments, the camera 129 operates to generate RGB-D images in which each pixel has corresponding photometric information and geometric information (depth and/or distance). In such embodiments, the camera 129 may, for example, take the form of an RGB camera that operates in association with a LIDAR or IR sensor, in particular a LIDAR camera or IR camera, configured to provide both photometric information and geometric information. The LIDAR camera or IR camera may be separate from or directly integrated with the RGB camera. Alternatively, or in addition, the camera 129 may comprise two RGB cameras configured to capture stereoscopic images, from which depth and/or distance information can be derived.

In some embodiments, the AR-HMD 123 may further comprise a variety of sensors 130. In some embodiments, the sensors 130 include sensors configured to measure one or more accelerations and/or rotational rates of the AR-HMD 123. In one embodiment, the sensors 130 include one or more accelerometers configured to measure linear accelerations of the AR-HMD 123 along one or more axes (e.g., roll, pitch, and yaw axes) and/or one or more gyroscopes configured to measure rotational rates of the AR-HMD 123 along one or more axes (e.g., roll, pitch, and yaw axes). In some embodiments, the sensors 130 may include inside-out motion tracking sensors configured to track human body motion of the user within the environment, in particular positions and movements of the head, arms, and hands of the user.

The display screen 128 may comprise any of various known types of displays, such as LCD or OLED screens. In at least one embodiment, the display screen 128 is a transparent screen, through which a user can view the outside world, on which certain graphical elements are superimposed onto the user's view of the outside world. In the case of a non-transparent display screen 128, the graphical elements may be superimposed on real-time images/video captured by the camera 129. In further embodiments, the display screen 128 may comprise a touch screen configured to receive touch inputs from a user.

The AR-HMD 123 may also include a battery or other power source (not shown) configured to power the various components within the AR-HMD 123, which may include the processing system 121, as mentioned above. In one embodiment, the battery of the AR-HMD 123 is a rechargeable battery configured to be charged when the AR-HMD 123 is connected to a battery charger configured for use with the AR-HMD 123.

The program instructions stored on the memory 126 include an AR tutoring program 133. As discussed in further detail below, the processor 125 is configured to execute the AR tutoring program 133 to enable the authoring and provision of AR tutorials for operating digital instruments. In one embodiment, the AR tutoring program 133 is implemented with the support of Microsoft Mixed Reality Toolkit (MRTK). Image cropping and perspective change functionalities (discussed below) may be implemented with OpenCV. Voice-to-text functionalities (discussed below) may be implemented with the Hololens built-in library. In one embodiment, the program instructions stored on the memory 126 further include an AR graphics engine 134 (e.g., Unity3D engine), which is used to render the intuitive visual interface for the AR tutoring program 133. Particularly, the processor 125 is configured to utilize the AR graphics engine 134 to superimpose on the display screen 128 graphical elements for the purpose of authoring tutorials for operating digital instruments, as well as guiding a learner with graphical tutorial elements during provision of AR tutorials for operating digital instruments. In the case of a non-transparent display screen 128, the graphical elements may be superimposed on real-time images/video captured by the camera 129.

In the illustrated exemplary embodiment, the hand wearable controller(s) 122 comprise sensors 132 and haptics 131. In at some embodiments, the hand wearable controller 122 are in the form of a glove, which is worn by the user and the user interface includes sensors for detecting interactions with physical user interfaces. The sensors 132 at least include force or pressure sensors, which may be attached at the fingertips of the user. In some embodiments, the sensors 132 may further include one or more accelerometers configured to measure linear accelerations of the hand wearable controller 122 along one or more axes and/or one or more gyroscopes configured to measure rotational rates of the hand wearable controller 122 along one or more axes. The haptics 131 include one or more transducers configured to generate perceptible haptic vibrations or the like for the user. The hand wearable controller(s) 122 further include one or more transceivers (not shown) configured to communicate inputs from the user 15 to the processing system 121.

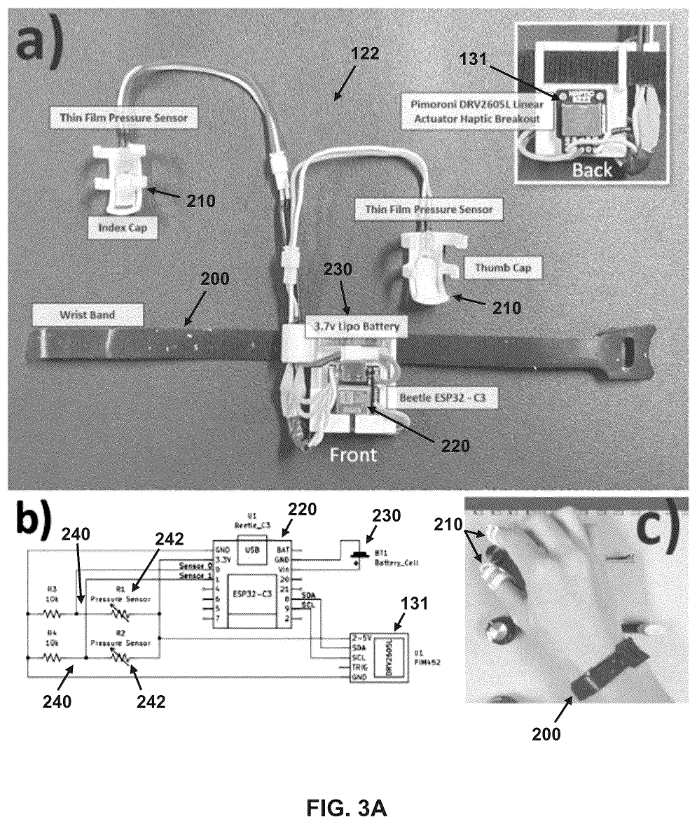

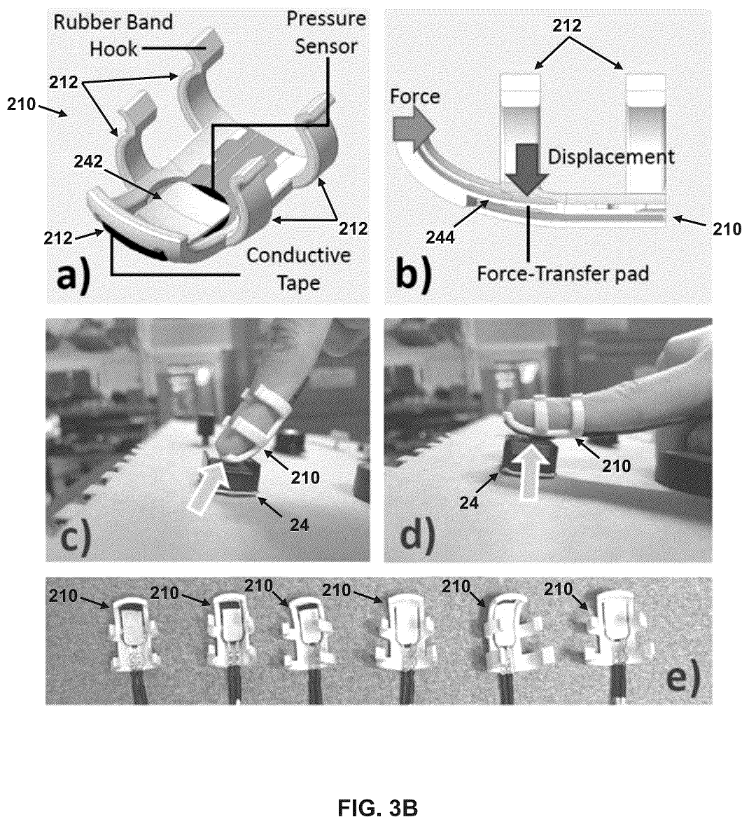

The hand wearable controller 122 is configured to detect when an interaction takes place and provides haptic feed-back when a novice user performs an incorrect interaction. FIG. 3A shows one exemplary embodiment of the hand wearable controller 122. As shown in illustration a), the hand wearable controller 122 has a minimalist design with only three components—a wristband 200 and two finger caps 210. Thus, the hand wearable controller 122 only minimally alters the appearance of the user's hand and fingers, which means it is less likely to interfere with hand-tracking algorithms of the digital instrument tutorial system 100. Additionally, the reduced bulkiness contributes to smoother operation. In one embodiment, the finger caps 210 are installed on the tips of the user's index finger and thumb, as they are the only one or two fingers involved in the interactions with the physical user interface 24 of the digital instrument 20. In one embodiment, the hand wearable controller 122 adopts thin film pressure sensors that can measure pressure strength applied on the fingers. The wristband holds a microprocessor 220, a linear actuator haptic module 131, and a battery 230. The microprocessor 220 has Wi-Fi capability which allows the wearable to communicate with the AR-HMD 123. To optimize hand tracking, these components are all hidden beneath the user's wrist when the hand wearable controller 122 is worn, as shown in illustration c) of FIG. 3A. Illustration b) of FIG. 3A shows a circuit diagram of the hand wearable controller 122. As can be seen, the microprocessor 220 is operably connected to pressure sensing circuits 240 and to the linear actuator haptic module 131. The pressure sensing circuits 240 incorporate pressure sensors 242, which are integrated into the finger caps 210

FIG. 3B shows the finger caps 210 of the hand wearable controller 122 in greater detail. As shown in illustrations a) and b), the profile (i.e., curvature) of the finger cap 210 is designed to conform to the profile of a fingertip. In one embodiment, conductive tapes 212 are added on the fingertips to support touchscreen operations. The finger cap 210 includes two finger bands 214 that can be tightened by rubber bands, via a rubber band hook at their ends, to hold he finger cap 210 in its place. As shown in illustration e), for each finger, three sizes (small, medium, large) of the finger caps 210 are provided. The pressure sensor 242 is secured by a slot and a set of buckles. Additionally, in the illustrated embodiment, to keep the finger cap 210 from being excessively cumbersome by attaching multiple pressure sensors 242, the hand wearable controller 122 only includes one pressure sensor in each finger cap 210 which provides an effective sensing area of, for example, 9 mm. However, this pressure sensor 242 alone can only detect a press gesture while a poke gesture remains undetected. To address this issue, the hand wearable controller 122 includes a force-transfer pad 244 that can redirect the force applied elsewhere to the pressure sensor, as shown in illustration b). With this design, the users can perform either the poke gesture, as shown in illustration c), or the press gesture, as shown in illustration d), to interact with the physical user interface 24.

### Methods for Providing AR Tutorials for Operating Digital Instruments

A variety of methods, workflows, and processes are described below for enabling the operations and interactions of the AR system 120. In these descriptions, statements that a method, workflow, processor, and/or system is performing some task or function refers to a controller or processor (e.g., the processor 125) executing programmed instructions (e.g., the AR tutoring program 133, the AR graphics engine 134) stored in non-transitory computer readable storage media (e.g., the memory 126) operatively connected to the controller or processor to manipulate data or to operate one or more components in the digital instrument tutorial system 100 to perform the task or function. Additionally, the steps of the methods may be performed in any feasible chronological order, regardless of the order shown in the figures or the order in which the steps are described.

Additionally, various AR graphical user interfaces are described for operating the AR system 120. In many cases, the AR graphical user interfaces include graphical elements that are superimposed onto the user's view of the outside world or, in the case of a non-transparent display screen 128, superimposed on real-time images/video captured by the camera 129. In order to provide these AR graphical user interfaces, the processor 125 executes instructions of the AR graphics engine 134 to render these graphical elements and operates the display screen 128 to superimpose the graphical elements onto the user's view of the outside world or onto the real-time images/video of the outside world. In many cases, the graphical elements are rendered at a position that depends upon positional or orientation information received from any suitable combination of the sensors 130 and the camera 129, so as to simulate the presence of the graphical elements in the real-world environment. However, it will be appreciated by those of ordinary skill in the art that, in some cases, an equivalent non-AR graphical user interface can also be used to operate the AR tutoring program 133, such as a user interface provided on a further computing device such as a laptop computer, a tablet computer, a desktop computer, or a smartphone.

Moreover, various user interactions with the AR graphical user interfaces and with interactive graphical elements thereof are described. In order to provide these user interactions, the processor 125 may render interactive graphical elements in the AR graphical user interface, receive user inputs from the user, for example via gestures performed in view of the one of the cameras 29 or other sensor, and execute instructions of the AR tutoring program 133 to perform some operation in response to the user inputs.

Finally, various forms of motion tracking are described in which spatial positions and motions of the user or of other objects in the environment are tracked. In order to provide this tracking of spatial positions and motions, the processor 125 executes instructions of the AR tutoring program 133 to receive and process sensor data from any suitable combination of the sensors 130 and the camera 129, and may optionally utilize visual and/or visual-inertial odometry methods such as simultaneous localization and mapping (SLAM) techniques.

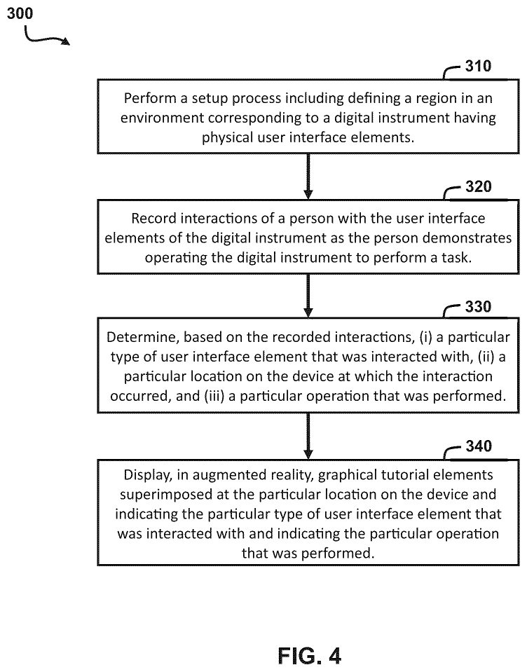

FIG. 4 shows a logical flow diagram for a method 300 for authoring an AR tutorial for operating a digital instrument. The method 300 advantageously provides an automated authoring workflow for users (e.g., an expert user and/or author) to create sequential AR tutorials for digital instruments by intuitive embodied demonstration. The method 300 advantageously utilizes a multimodal approach that combines finger pressure and gesture tracking to translate the author's interactions and operations into AR visualizations.

The method 300 begins with performing a setup process including defining a region in an environment corresponding to a digital instrument having physical user interface elements. (block 310). Particularly, during an initial set up process, the processor 125 defines, based on user inputs, a spatial region, referred to herein as an interaction area, that is associated with and encompasses a digital instrument having a physical user interface that is interacted with to operate the digital instrument. The interaction area serves two purposes. Firstly, as discussed in greater detail below, the system 100 will only interpret the pressure signals received from the hand wearable controller 122 as an interaction while the user's hand is located within the interaction area. For instance, when the user taps the table or rubs his or her fingers outside of the interaction area, the system 100 disregards the pressure signals received from the hand wearable controller 122. This ensures that only interactions associated with the digital instrument will be registered. Secondly, as discussed in greater detail below, each time the user's hand enters the interaction area, a baseline value for calculating a press threshold is reset to a current pressure sensor value received from the hand wearable controller 122.

Additionally, in some embodiments, during the initial set up process, the processor 125 defines, based on user inputs, a further spatial region, referred to herein as an image capture area, around a portion of the digital instrument of which images are to be automatically captured during a demonstration of operating the digital instrument. The image capture area may be, for example, defined around a display screen of the digital instrument. However, in general, the image capture area may be defined anywhere that is of interest for image capture after each step of task that is to be demonstrated.

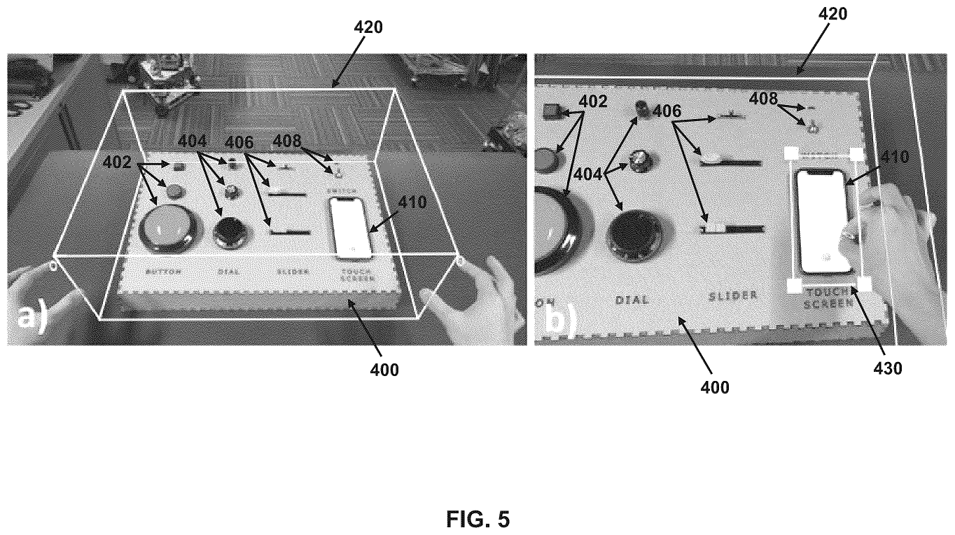

FIG. 5 shows the initial setup process with respect to an exemplary digital instrument 400. The digital instrument 400 has a physical user interface with a variety of user interface elements, including buttons 402, dials 404, sliders 406, switches 408, and a touch screen 410. Particularly, in the initial setup process, the user draws a bounding box 420 that specifies the interaction area, shown in illustration a) of FIG. 5. The user draws the bounding box using hand gestures, such as pinch and dragging gestures. Additionally, in a similar manner, the user draws a further bounding box 430 that specifies the image capture area around the touch screen 410, shown in illustration b) of FIG. 5.

The method 300 continues with recording interactions of a person with the user interface elements of the digital instrument as the person demonstrates operating the digital instrument to perform a task (block 320). Particularly, after the initial setup process, the user demonstrates operating the digital instrument in a step-by-step manner to perform a task that is to be taught by the AR tutorial. In general, the task comprises a sequence of interactions and/or operations with individual user interface elements of the digital instrument, referred to herein as steps. Each step includes an interaction with a particular type of user interface element at a particular location on the device and a particular operation that is performed with respect to the particular type of user interface element.

The processor 125 operates at least one sensor to record interactions of a user with a plurality of physical user interface elements of the digital instrument as the user demonstrates operating the digital instrument in a step-by-step manner to perform the task, while wearing the AR-HMD 123 and the hand wearable controller 122. Particularly, the pressure sensors 242 of the hand wearable controller 122 measure pressures applied with individual fingers of a hand of the user and generate pressure sensors signals, which are received by the processor 125. Meanwhile, the processor 125 operates the camera 129 of the AR-HMD 123 to capture images and/or video of the hand of the user and of the digital instrument. The processor 125 stores values of the received pressure sensor signals and the captured images and/or video in the memory 126 for further processing.

As discussed in greater detail below, in at least some embodiments, the user is expected to perform each interaction and operation with respective user interface elements of the digital interface using predetermined gestures associated with particular types of user interface elements. However, in other embodiments, the system 100 is designed to accommodate a larger variety of unfamiliar and uncommon gestures for interacting with particular types of user interface elements.

The method 300 continues with determining, based on the recorded interactions, (i) a particular type of user interface element that was interacted with, (ii) a particular location on the device at which the interaction occurred, and (iii) a particular operation that was performed (block 330). Particularly, as the user demonstrates each step of operating the digital instrument to perform the task, he or she performs a particular operation, actuation, and/or adjustment with respect to a particular type of user interface element of the digital instrument at a particular location on the digital instrument. Based on the recorded interactions, the processor 125 determines which particular type of user interface element was interacted with, at what particular location, and what particular operation, actuation, and/or adjustment was performed with respect to the user interface element.

In summary, the processor 125 first determines which particular type of user interface element was interacted with. To these ends, the processor 125 determines a location and pose of the hand based on the images. Additionally, the processor 125 determines the location and pose of the digital instrument itself. The processor 125 determines which particular type of user interface element was interacted with based on the pose of the hand and based on the pressure signals received from the hand wearable controller 122.

In some embodiments, the processor 125 detects that a particular type of user interface element of the digital instrument was interacted with in response to a pressure being applied with at least one finger of the hand while the hand is located in the interaction region associated with the digital instrument.

In some embodiments, the processor 125 detects that a particular type of user interface element of the digital instrument was interacted with in response to pressures being applied with a predetermined number of fingers (e.g., exactly one finger or exactly two fingers) of the hand while the hand is located in the interaction region associated with the digital instrument.

In some embodiments, the processor 125 detects that a particular type of user interface element of the digital instrument was interacted with in response to a pressure being applied with at least one finger of the hand while the hand has a defined pose (e.g., one-finger touch gesture or a two-finger pinch gesture) associated with the particular type of user interface element and while the hand is located in the interaction region associated with the digital instrument.

Finally, the processor 125 detects the particular operation, actuation, and/or adjustment that was performed with respect to the particular type of user interface element. To these ends, the processor 125 determines transformations of the location and pose of the hand over time (e.g., translation/displacement or rotations). In some embodiments, the processor 125 determines the particular operation, actuation, and/or adjustment that was performed based on the transformation of the hand while the pressure is applied with the at least one finger of the hand and while the hand is located in an interaction region associated with the digital instrument.

In some embodiments, the digital instrument tutorial system 100 supports at least five types of physical user interface elements on digital instruments, including: (1) touchscreens, (2) switches, (3) buttons, (4) knobs/dials, and (5) sliders. These exemplary physical user interface elements generally can cover the majority of operations performed on a majority of digital instruments. Operations on the touchscreen may include interactions with digital user interface elements, such as digital buttons and digital sliders, whose operation logic resembles their physical counterparts. They are prevalent in digital instruments that feature touchscreens (e.g., printers, and washing machines) and cover most of their touchscreen operations. In this way, the digital instrument tutorial system 100 also supports interactions with digital user interface elements that are displayed on touch screens. In some embodiments, the digital instrument tutorial system 100 supports sophisticated touchscreen operations, such as those involving multi-touch interactions.

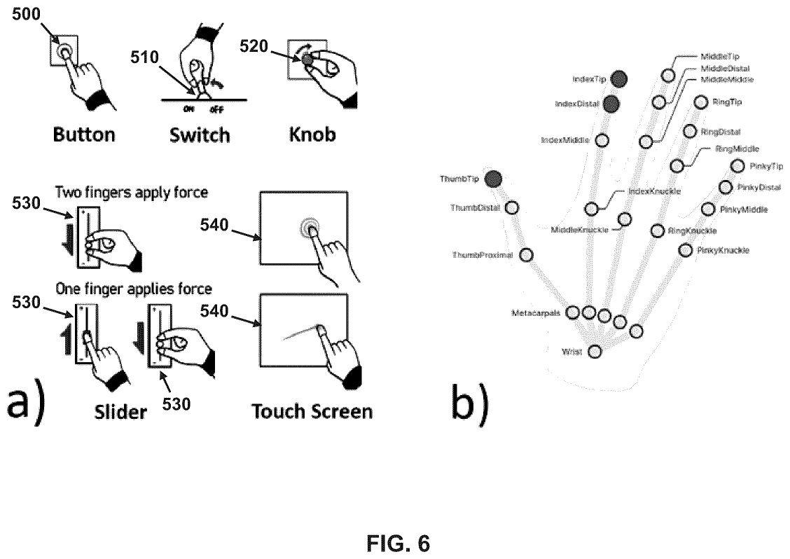

FIG. 6 shows a taxonomy for gestures associated with each operation, as well as the hand joints that are tracked by the digital instrument tutorial system 100. Particularly, as shown in illustration a), a user can interact with and operate a button 500 with a one-finger press gesture or poke gesture using the index finger. A user can interact with and operate a switch 510 with a two-finger pinch and toggle gesture using the index finger and the thumb. A user can interact with and operate a knob 520 with a two-finger pinch and rotate gesture using the index finger and the thumb. A user can interact with and operate a slider 530 with a two-finger pinch and slide gesture using the index finger and the thumb, in which both fingers apply force or in which only one finger applies force, or with a one-finger sliding gesture using the index finger. Finally, a user can interact with and operate a touchscreen 540 with a one-finger tap gesture using the index finger or a one-finger slide gesture using the index finger.

In one embodiment, the digital instrument tutorial system 100 requires users to perform respective operations using the gestures included in the supported taxonomy. However, this exemplary taxonomy is far from comprehensive, and it is likely that some users will prefer to perform demonstrations using gestures outside of this exemplary taxonomy. Thus, in some embodiments, the digital instrument tutorial system 100 is configured to support a much wider variety of additional and unfamiliar gestures.

As mentioned above, the processor 125 advantageously utilizes a multimodal approach for interaction detection that combines finger pressure and gesture tracking to accurately identify the interactions and operations performed by the user as he or she demonstrates a task. To these ends, the processor 125 processes the images captured by the camera 129 during the demonstration to determine, not only a real-time location of the hand, but also a real-time location of every joint in the hand, as shown in illustration b) of FIG. 6. Based on the real-time locations of the joints in the hand, the processor 125 determines a real-time pose and/or gesture of the hand being performed by the hand, and determines transformations of the pose and/or gesture of the hand over time. The processor 125 may utilize a gesture-tracking algorithm that is built into the AR-HMD 123 for the purpose of these hand joint and hand pose determinations. Based on the determined gesture and hand pose/gesture information and the pressure sensor signals, the processor 125 applies a decision-tree-based algorithm to classify the interaction based on this information (i.e., determine the type of user interface element that was interacted with).

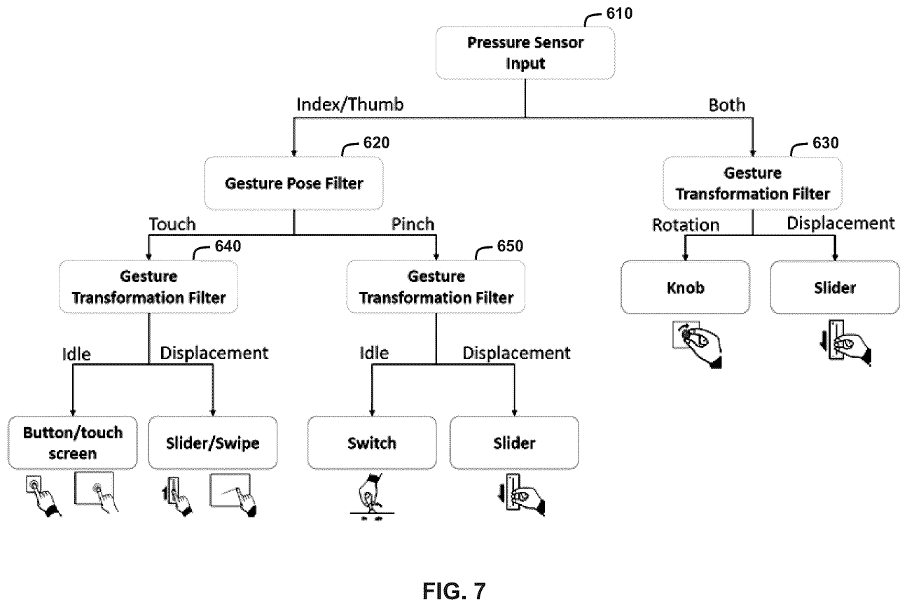

FIG. 7 shows a decision-tree-based algorithm 600 for classifying interactions with user interface elements of the digital instrument. It will be appreciated that, when the user's hand is co-located with a particular user interface element, the processor 125 must be able to distinguish between the user actually interacting with the particular user interface element and merely occluding or touching the particular user interface element. This is challenging because, in many cases the user interface element is much smaller than the hand and is thus easily occluded in a manner that prevents accurate tracking of the user interface element. To address the issue of hand occlusion during manipulation of physical user interface elements, the decision-tree-based algorithm 600 does not require the trajectories of the manipulated user interface elements to be tracked. Instead, the decision-tree-based algorithm 600 leveraged by the processor 125 advantageously classifies interactions with user interface elements based only on hand tracking and the pressure sensor signals from the hand wearable controller 122. The approach of the decision-tree-based algorithm 600 can be summarized into two steps: 1) detecting when the user's hand makes contact with and manipulates the user interface elements, and 2) recognizing how the user manipulates the user interface elements.

At step 610 of the decision-tree-based algorithm 600, the processor 125 receives pressure sensor inputs from the hand wearable controller 122. Based on the pressure sensor inputs, the processor 125 differentiates between (left-hand branch) interactions in which the user applies pressure to a user interface element using only one finger and (right-hand branch) interactions in which the user applies pressure to a user interface element using both fingers.

In at least some embodiments, the processor 125 compares the magnitude of the pressure sensor input values for each fingertip, with a predetermined threshold value, referred to herein as the ‘press threshold.’ If the pressure sensor input value corresponding to the index finger exceeds the press threshold, then the processor 125 determines that the user is operating a user interface element using his or her index finger. Likewise, if the pressure sensor input value corresponding to the thumb exceeds the press threshold, then the processor 125 determines that the user is operating a user interface element using his or her thumb. This process enables the processor 125 to distinguish between the user manipulating a user interface element and merely placing his or her fingers on the user interface element. Once the pressure sensor's analog reading exceeds the press threshold, the processor 125 determines that the operation of the particular type of user interface element has started and records the interaction start time. Likewise, if the reading decreases lower than the press threshold, the processor 125 determines that the operation of the particular type of user interface element has ended and records the interaction end time.

In at least some embodiments, to enrich the functionality of the hand wearable controller 122, the system 100 incorporates another concept called a ‘half-press.’ A half-press threshold is set equal to a predetermined percentage (e.g., half) of the press threshold so that half-presses can be detected, which are indicative of operations that are about to happen. This value will be later utilized for a preemptive warning feature. If the pressure sensor input value corresponding to the index finger exceeds the half-press threshold, then the processor 125 determines that the user is likely about to operate a user interface element using his or her index finger. Likewise, if the pressure sensor input value corresponding to the thumb exceeds the half-press threshold, then the processor 125 determines that the user is likely about to operate a user interface element using his or her thumb.

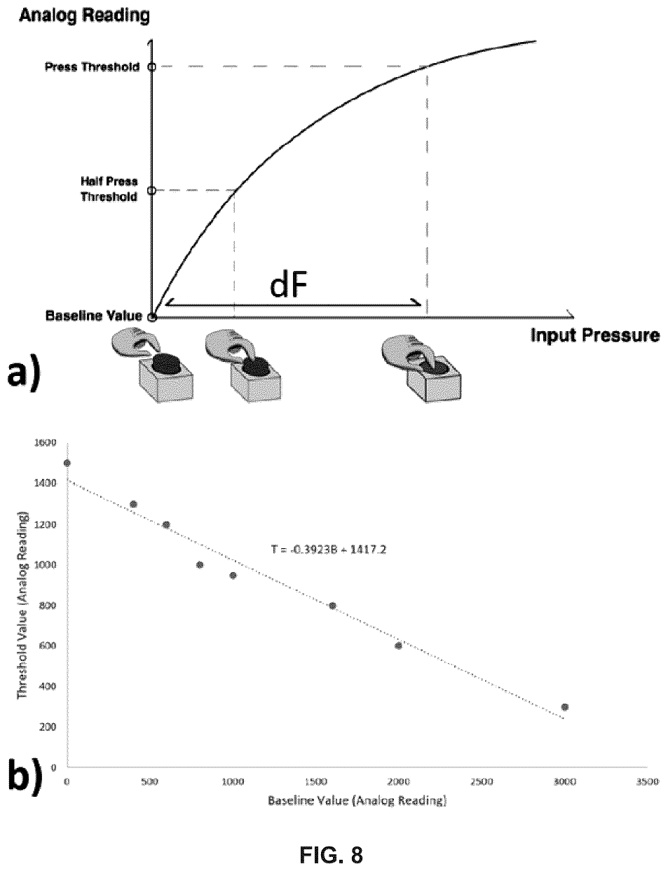

FIG. 8 shows measurement behaviors of the pressure sensors 240 of the hand wearable controller 122. Illustration a) of FIG. 8 shows a relationship between a pressure sensor's analog reading and the pressure that is applied. To detect the physical interaction between the finger and the user interface element, a minimal force change (dF), referred to herein as the ‘threshold value,’ may be set to a predetermined value (e.g., 350 g). In other words, the user has to exert at least that amount of force onto the user interface element before they could actually move the user interface element. This value is determined after experimenting with the operation on various physical user interface elements on common instruments.

In at least some embodiments, the processor 125 calculates the press threshold dynamically based on the threshold value and a ‘baseline value.’ The baseline value may be different for each finger. Each time the user's hand enters into the interaction area, the processor 125 resets the baseline value for each finger equal to a current pressure sensor signal value of that finger. The baseline value varies between users and fluctuates over time, due to different wearing habits and the current pose of the finger. In some embodiments, the processor 125 calculates the press threshold based on a linear relationship between analog readings of the threshold value and baseline value, which may be determined experimentally. Illustration b) of FIG. 8 shows an exemplary linear relationship between analog readings of the threshold value (i.e., the minimal force change) being applied and the baseline value.

With reference again to FIG. 7, if the processor 125 determines that the user has applied pressure to a user interface element (that exceeds the press threshold) using only one finger, then the decision-tree-based algorithm 600 proceeds down the left-hand branch to step 620. Otherwise, if the processor 125 determines that the user has applied pressure to a user interface element (that exceeds the press threshold) using both fingers, then the decision-tree-based algorithm 600 proceeds down the right-hand branch to step 630.

At step 620 (“Gesture Pose Filter”), based on the hand joint locations and/or hand pose, the processor 125 differentiates between (1) interactions performed using a one-finger touch gesture and (2) interactions performed using a two-finger pinch gesture. It should be appreciated that, using the exemplary gesture taxonomy discussed above with respect to illustration a) of FIG. 6, all of the gestures for the operations require only the index finger, the thumb, or both. This is advantageous because the index finger and thumb are the two fingers that are least likely to be occluded by other fingers during operations. Therefore, information from two or three joints (e.g., IndexTip, IndexDistal, ThumbTip in illustration b) of FIG. 6) on these two fingers is sufficient for the processor 125 to differentiate between the one-finger touch gesture and the two-finger pinch gesture.

With reference again to FIG. 7, if the processor 125 determines that the interaction was performed using a one-finger touch gesture, then the decision-tree-based algorithm 600 proceeds down the left-hand branch to step 640. Otherwise, if the processor 125 determines that the interaction was performed using a two-finger pinch gesture, then the decision-tree-based algorithm 600 proceeds down the right-hand branch to step 650.

At each of the steps 630, 640, 650 (“Gesture Transformation Filter”), the processor 125 classifies the interaction that was performed based on the transformation hand joint locations and/or hand pose over time. Particularly, at step 630, the processor 125 determines that the user interacted with a knob if there was a rotation of the two-finger pinch gesture between the interaction start time and the interaction end time. Conversely, at step 630, the processor 125 determines that the user interacted with a slider if there was a displacement (translation) of the two-finger pinch gesture between the interaction start time and the interaction end time.

Similarly, at step 640, the processor 125 determines that the user interacted with a button or tapped a touch screen if there was minimal or no transformation (idle) of the one-finger touch gesture between the interaction start time and the interaction end time. Conversely, at step 640, the processor 125 determines that the user interacted with a slider or swiped on a touch screen if there was displacement (translation) of the one-finger touch gesture between the interaction start time and the interaction end time. Finally, the processor 125 determines that the interaction was with a touch screen if the was located within the boundary of a touch screen (which may have been user-defined during the initial setup process). Otherwise, the processer 125 determines that the interaction was with a physical button/slider.

Finally, at step 650, the processor 125 determines that the user interacted with a switch if there was minimal or no transformation (idle) of the two-finger pinch gesture between the interaction start time and the interaction end time. Conversely, at step 650, the processor 125 determines that the user interacted with a slider if there was displacement (translation) of the two-finger pinch gesture between the interaction start time and the interaction end time.

Once the interaction has been classified, the processor 125 determines what operations was performed with respect to the particular type of user interface element. In the case of pressing a button, toggling a switch, and tapping a touch screen, these interactions occur in a discrete manner (i.e., they either occurred or they didn't occur). However, in the case of a slider, a knob, and swiping on a touch screen, these interactions occur in a continuous manner (i.e., there is meaningful variation in the manner in which they can occur). For such continuous operations, the processor 125 determines a magnitude of adjustment, a time series of magnitudes, and/or a time series of positions that characterize the particular operation performed. In one example, the processor 125 determines a magnitude of an adjustment to a slider or knob based on a translational or rotational difference between the pose of the hand at the interaction start time and the pose of the hand at the interaction end time. In the case of the slider, the magnitude of the operation corresponds to a distance between the position of the hand at the interaction start time and the position of the hand at the interaction end time. In the case of the knob, the magnitude of the operation corresponds to a relative angle between a pose of the hand at the interaction start time and the pose of the hand at the interaction end time. In one embodiment, the processor 125 determines this angle by (i) determining a first vector between a tip of the index finger and a tip of the thumb at the interaction start time, (ii) determining a second vector between the tip of the index finger and the tip of the thumb at the interaction end time, and (iii) calculating an angle between the first vector and the second vector.

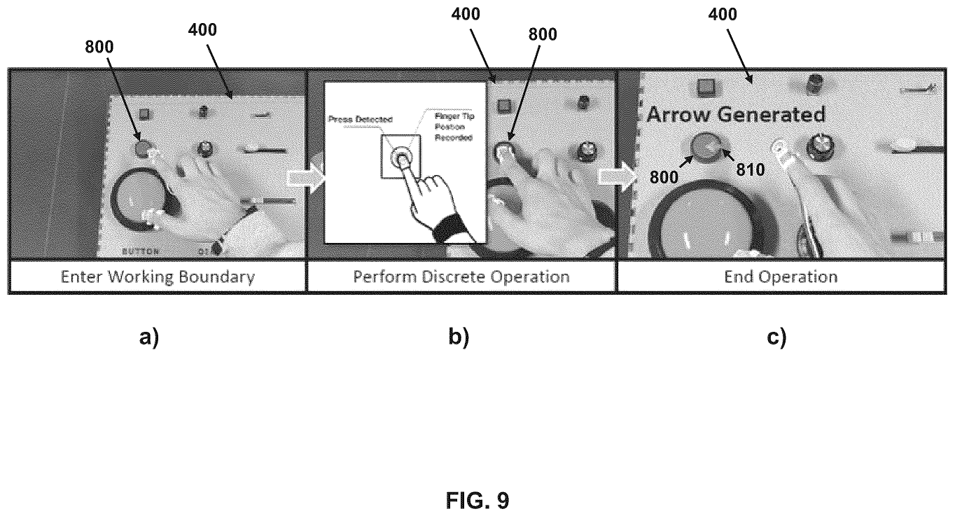

FIG. 9 shows a workflow for demonstrating a discrete operation with respect to a user interface element of the digital instrument 400. As shown in illustration a), the user's hand enters the working boundary (i.e., the user-defined interaction area that encompasses the digital instrument 400). At this time, the processor 125 resets the baseline value for each finger as being equal to a current pressure sensor signal value for that finger and determines the press threshold. Next, as shown in the illustration b), the user presses a button 800 with a one-finger touch gesture. Based on the pose of the user's hand pose and the pressure sensor signal values for each finger, the processor 125 determines that the user has pressed a button. Particularly, the processor 125 determines that (i) only the index finger has a pressure sensor value that exceeds the press threshold, (ii) the user's hand has a pose corresponding to a one-finger touch gesture, and (iii) there was minimal or no displacement (idle) between the pose of the hand at the interaction start time and the pose of the hand at the interaction end time. From this information, the processor 125 classifies the interaction as an interaction with a button. Once the interaction with the button 800 is detected, the processor 125 stores, in the memory 126, the location of the hand, in particular a location of the tip of the index finger, during the interaction.

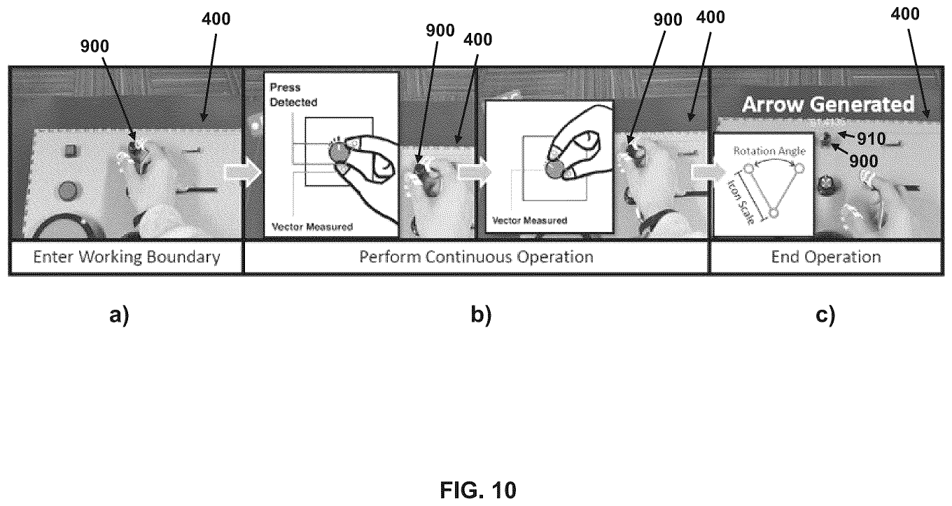

FIG. 10 shows a workflow for demonstrating a continuous operation with respect to a user interface element of the digital instrument 400. As shown in illustration a), the user's hand enters the working boundary and the processor 125 resets the baseline value and determines the press threshold. Next, as shown in the illustration b), the user turns a knob with a two-finger pinch gesture. Based on the pose of the user's hand and the pressure sensor signal values for each finger, the processor 125 determines that the user has turned a knob. Particularly, the processor 125 determines that (i) both the thumb and the index finger have pressure sensor values that exceed the press threshold, (ii) the user's hand has a pose corresponding to a two-finger pinch gesture, and (iii) there was rotational transformation between the pose of the hand at the interaction start time and the pose of the hand at the interaction end time. From this information, the processor 125 classifies the interaction as an interaction with a button.

Once the interaction with the knob 900 is detected, the processor 125 determines a magnitude of the adjustment to the knob 900. Particularly, the processor 125 determines a first vector between a tip of the index finger and a tip of the thumb at the interaction start time and a second vector between the tip of the index finger and the tip of the thumb at the interaction end time. The processor 125 determines the magnitude of the adjustment to the knob 900 as equal to an angle between the first vector and the second vector. Next, the processor 125 stores, in the memory 126, the location of the hand, in particular an average of the location of the tip of the index finger and the tip of the thumb, during the interaction. Additionally, the processor 125 stores the calculated angle between the first vector and the second vector, as well as a length of the first vector and the second vector.

It should be appreciated that, in both examples, the physical user interface elements need not be tracked by the system 100, thus overcoming any issues with occlusion. Instead, the location of the interaction and the type of user interface element that was interacted with are determined based on the pressure sensor information and gesture-tracking information. As a result, users are not required to retrain new tracking models for each different digital instrument. In other words, the tracking technique is designed to scale to diverse user interfaces with different shapes and sizes without further restraining or fine-tuning. Such flexibility is not possible with traditional tracking techniques that directly track the physical user interface elements themselves.

The method 300 continues with displaying, in augmented reality, graphical tutorial elements superimposed at the particular location on the device and indicating the particular type of user interface element that was interacted with and indicating the particular operation that was performed (block 340). Particularly, after the user demonstrates each step of operating the digital instrument to perform the task, the processor 125 operates the display screen 128 of the AR-HMD 123 to display, in an AR graphical user interface, an AR graphical tutorial element or visualization that indicates the particular type of user interface element that was interacted with and indicates the particular operation, actuation, and/or adjustment that was performed. The graphical tutorial element is superimposed at the location on the digital instrument at which the user interacted with the particular type of user interface element, which is one and the same with the location of the user interface element itself.

In this way, as user demonstrates each step of operating the digital instrument to perform the task, the interactions and operations of the user are automatically translated into corresponding AR visualizations. The graphical tutorial elements displayed to the user are a preview of the AR tutorial content that will be provided to a novice user when providing the AR tutorial. This automated process is often referred to as authoring by embodied demonstration. It relieves users from continuous interaction with virtual objects, which could be both time-consuming and mentally demanding.

In some examples, the graphical tutorial elements include a virtual arrow that is superimposed on or adjacent to the digital instrument. In one embodiment, the virtual arrow is oriented to point toward the location on the digital instrument at which the user interacted with the particular type of user interface element. With reference again to FIG. 9, as show in illustration c), after the user demonstrates pressing the button 800, the processor 125 renders a virtual arrow 810 that points toward the button 800. In one embodiment, the virtual arrow is superimposed at or adjacent to the location on the digital instrument at which the user interacted with the particular type of user interface element and is oriented to point toward a direction in which the particular type of user interface element must be manipulated to perform the particular operation, actuation, and/or adjustment. With reference again to FIG. 10, as show in illustration c), after the user demonstrates turning the knob 900, the processor 125 renders a virtual arrow 910 shows direction of rotation of the knob 900. In one embodiment, the virtual arrow has a size that is proportional to a size of the particular user interface element that was interacted with. In one embodiment, the virtual arrow has a length that is proportional to a magnitude of an adjustment that must be made to perform the particular operation, actuation, and/or adjustment. As shown in FIG. 10, the virtual arrow has a size corresponding to a size of the knob 900 and a length corresponding to the rotation angle of the operation.

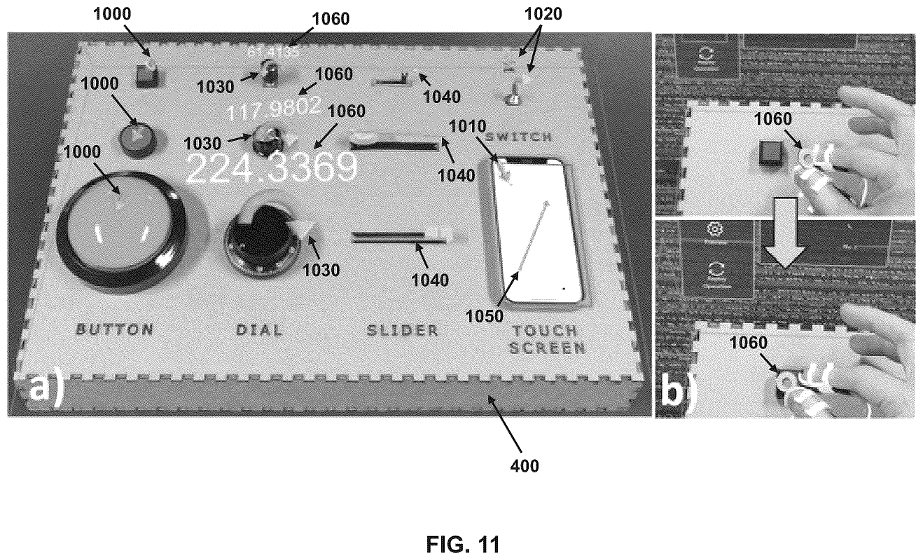

FIG. 11 shows automatically generated AR content for a variety of different user interface operations, and user adjustment of the generated AR content. After the operation is detected, the processor 125 renders virtual arrows with different scales and orientations on top of the associated user interface elements, as shown in illustration a) of FIG. 11. It should be appreciated that different types of tasks require different formats of AR content, and that the virtual arrows discussed and described herein are merely an example of AR graphical tutorial content that might be generated and displayed.

For discrete operations (i.e., press a button, tapping a touchscreen, toggling a switch), the processor 125 retrieves the location at which the operation takes place as well as the hand pose during operation. Based on the information, the processor 125 generates a virtual arrow 1000, 1010, 1020 that appears at the exact location where the finger was detected at a start time of the interaction. The processor 125 also sets the orientation of the virtual arrow 1000, 1010, 1020 based on the hand pose at a start time of the interaction. In some embodiments, for button operations, the virtual arrows 1000 point in the same direction as the index finger. Likewise, to touch screen tapping operations, the virtual arrow 1010 points in the same direction as the index finger. In contrast, for switch operations, the virtual arrows 1020 points from the finger which exerts force to the finger which does not, such that the arrow indicates a direction of adjustment of the switch.

While the size, shape, and length of the arrows is the same for discrete operations in the illustrated embodiment, this is not the case for continuous operations (i.e., turning a knob, swiping a touchscreen, or pushing a slider). For continuous operations, the processor 125 retrieves other information regarding the operations, such as the magnitude of the particular operation, actuation, and/or adjustment or the distance between fingers during the interaction. Based on this information, the processor 125 generates a virtual arrow 1030, 1040, 1050 that appears at the location at which the interaction occurred and with a size, shape, and length the conveys further information about the operation that was performed. In some embodiments, for knob operations, the virtual arrows 1030 have a size, length, and curvature that corresponds to the size and shape of the knob. For example, at both the beginning and the end of the knob operation, the processor 125 determines the thumb-to-index-finger vectors. Through vector sub-traction, the processor 125 calculates the rotated angle of the knob which sets the length of the virtual arrow 1030. Additionally, the processor 125 determines the distance between the index finger and thumb, i.e., lengths of the thumb-to-index-finger vectors, which sets the size (radius) of the virtual arrow 1030. Additionally, for slider operations, the virtual arrows 1040 have a length and orientation that matches the index finger's trajectory throughout the operation. Likewise, for touchscreen swiping operations, the virtual arrow 1050 similarly has a length and orientation that matches the index finger's trajectory throughout the operation.

The graphical tutorial elements may further include text that is superimposed on or adjacent to the digital instrument, for example next to a virtual arrow. In one embodiment, the text indicates the magnitude of an adjustment that must be made to perform the particular operation, actuation, and/or adjustment. With reference to FIG. 11, the processor 125 renders virtual text 1060 adjacent to the virtual arrows 1030, indicating a rotation angle of the operation of the knobs.

In some cases, the auto-generated virtual arrows may not live up to the user's standards due to detection inaccuracies. Therefore, the system 100 allows users to post-edit the auto-generated arrows by adjusting their locations, sizes, lengths and orientations. Particularly, in response to user inputs received from the user, the processor 125 adjusts a location, size, length, or orientation of a virtual arrow. The adjustment process is performed through direct manipulation of the virtual arrows, as shown in illustration b) of FIG. 11, in which a user adjusts the location of a virtual arrow 1060 to be co-located with a button.

Although virtual arrows can be easily interpreted, they may not convey sufficient instructions to guide users through complex tasks. Therefore, the system 100 further allows users to record their voices and capture the image of a specific area to convey additional information. Particularly, in some embodiments, the graphical tutorial elements may include an image that is superimposed on or adjacent to the digital instrument. Particularly, during the demonstration, the processor 125 operates the camera 129 to capture images of the digital instrument, in particular images of the image capture area that was previously defined (e.g., around a display screen of the digital instrument), and displays, in the AR graphical user interface, the captured image superimposed on or adjacent to the digital instrument. In some embodiments, the graphical tutorial elements include a text transcription of natural language speech uttered by the user during the demonstration. Particularly, during the demonstration, the processor 125 operates a microphone to record natural language speech from the user, transcribes the natural language speech into text, and displays, in the AR graphical user interface, the text superimposed on or adjacent to the digital instrument.

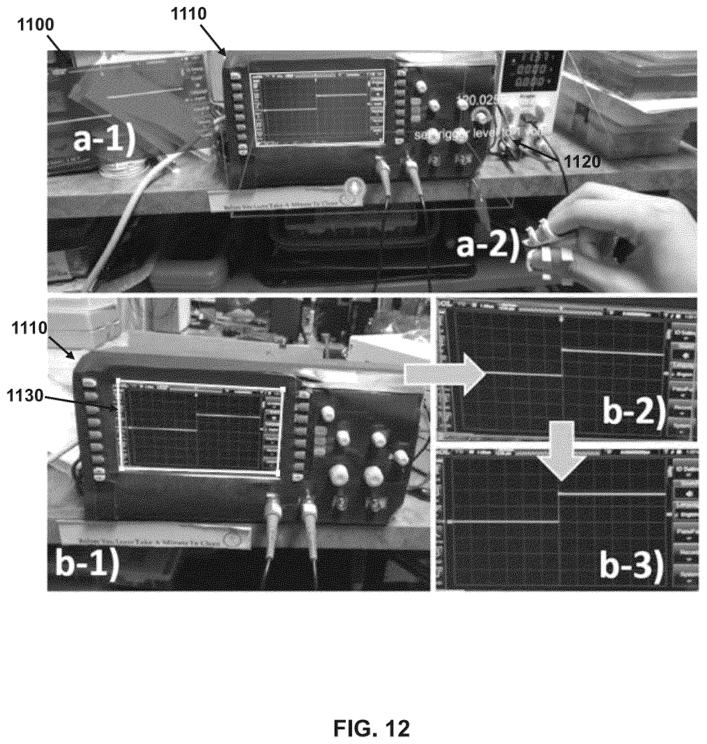

FIG. 12 shows processes for capturing additional AR tutorial content. As shown in illustration a-1) of FIG. 12, a screenshot 1100 of a screen of a digital instrument 1110 is displayed to the user adjacent to the digital instrument 1100. As shown in illustration a-2), after each operation, the user can perform a pinch gesture outside of the interaction area to record detailed instructions. The recording is transcribed to text 1120 which will be displayed on the side of the instrument (e.g., “set trigger level to 1 volt.”)

Unlike voice recording, which must be performed manually, the processor 125 operates the camera 129 to automatically capture images after each step. As discussed previously, during the initial setup process, the user manually specifies an image capture area for image capture by drawing a bounding rectangle 1130 around it. The bounding rectangle, which constantly appears during the authoring process, serves two purposes. First, it constantly reminds users of its location to prevent them from turning their heads away. Then, the bounding rectangle displayed in the captured image can facilitate the automatic image processing. As shown in illustration b-1) of FIG. 12, a raw image is captured from the camera 129. Next, as shown in illustration b-2) of FIG. 12, the processor 125 crops the image based on the bounding rectangle and, as shown in illustration b-3) of FIG. 12, the processor 125 generates the final image after perspective transformation. Specifically, the processor 125 segments the contour of the bounding rectangle by analyzing the image's RGB value. The retrieved contour helps the processor 125 determine the coordinates of the rectangle's four vertices. Based on these coordinates and the rectangle's original aspect ratio, the processor 125 automatically crops and corrects the image's perspective, for example using built-in functions from OpenCV. In other words, the final image that will be displayed alongside the instrument is cropped to what is contained within the bounding rectangle and the perspective is altered to provide users with a clearer view of the required information. To avoid occlusion of the screen, the processor 125 waits until the hands no longer appear between the AR headset and the screen area to capture the image. This is feasible because the processor 125 knows the location of the hand, the screen area, and the AR headset.

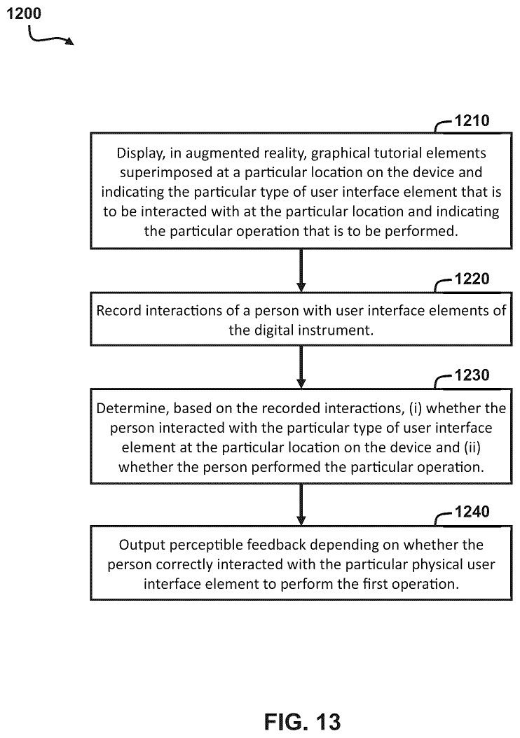

FIG. 13 shows a logical flow diagram for a method 1200 for providing an AR tutorial for operating a digital instrument. The method 1200 advantageously utilizes a multimodal approach that combines finger pressure and gesture tracking to translate a novice user's interactions and operations, and incorporates an automatic feedback mechanism that can determine whether the system should proceed to the next step or issue a visual-haptic warning based on the novice user's real-time operation.

The method 1200 begins with displaying, in augmented reality, graphical tutorial elements superimposed at a particular location on the device and indicating the particular type of user interface element that is to be interacted with at the particular location and indicating the particular operation that is to be performed (block 1210). Particularly, the memory 126 stores, and the processor 125 reads from the memory 126, tutorial data for an AR tutorial for operating a digital instrument to perform a task. In general, the task comprises a sequence of interactions and/or operations with individual user interface elements of the digital instrument, referred to herein as steps. Each step includes an interaction with a particular type of user interface element at a particular location on the digital instrument and a particular operation that is performed with respect to the particular type of user interface element. For each step of a task, the tutorial data indicates (i) a particular type of user interface element that is to be interacted with, (ii) a particular location on the digital instrument at which the particular type of user interface element is to be interacted with, and (iii) a particular operation, actuation, and/or adjustment that is to be performed.

As the user learns to perform the steps of the task to which the AR tutorial relates, the novice user wears the AR-HMD 123 and the hand wearable controller 122. Based on the tutorial data, the processor 125 operates the display screen 128 to display an AR graphical user interface including AR graphical tutorial elements or visualizations including a respective graphical tutorial element superimposed at the particular location on the digital instrument and indicating the particular type of user interface element that is to be interacted with and indicating the particular operation that is to be performed. The AR graphical tutorial elements or visualizations displayed to the novice user when providing the AR tutorial for operating the digital instrument are the same as those that were displayed to the expert user during the authoring process, which were described in greater detail above and not described again in detail here.

The method 1200 continues with recording interactions of a person with user interface elements of the digital instrument (block 1220). Particularly, as the user learns to perform the steps of the task, the processor 125 operates at least one sensor to record interactions of a user with the plurality of physical user interface elements of the digital instrument. Particularly, the pressure sensors 242 of the hand wearable controller 122 measure pressures applied with individual fingers of a hand of the user and generate pressure sensors signals, which are received by the processor 125. Meanwhile, the processor 125 operates the camera 129 of the AR-HMD 123 to capture images and/or video of the hand of the user and of the digital instrument. The processor 125 stores values of the received pressure sensor signals and the captured images and/or video in the memory 126 for further processing.

The method 1200 continues with determining, based on the recorded interactions, (i) whether the person interacted with the particular type of user interface element at the particular location on the device and (ii) whether the person performed the particular operation (block 1230). Particularly, as the user learns to perform each step of operating the digital instrument to perform the task, based on the recorded interactions, the processor 125 determines which type of user interface element was interacted with, a location at which the interaction occurred, and what operation, actuation, and/or adjustment was performed.

In summary, the processor 125 first determines which type of user interface element was interacted with. To these ends, the processor 125 determines a location and pose of the hand based on the images. Additionally, the processor 125 determines the location and pose of the digital instrument itself. The processor 125 determines which particular type of user interface element was interacted with based on the pose of the hand and based on the pressure signals received from the hand wearable controller 122.

Next, the processor 125 detects the operation, actuation, and/or adjustment that was performed. To these ends, the processor 125 determines transformations of the location and pose of the hand over time (e.g., translation/displacement or rotations). In some embodiments, the processor 125 determines the operation, actuation, and/or adjustment that was performed based on the transformation of the hand while the pressure is applied with the at least one finger of the hand and the hand is located in an interaction region associated with the digital instrument.

Finally, the processor 125 compares these determinations with the tutorial data to determine whether the novice user has interacted with the correct type of physical user interface element indicated in the tutorial data at the correct location on the digital instrument indicated in the tutorial data and (ii) whether the user has performed the correct operation, actuation, and/or adjustment indicated in the tutorial data. Particularly, the processor 125 compares the location of the novice user's hand with the location at which the interaction is to be performed, as indicated in the tutorial data. Additionally, the processor 125 compares the pose of the novice user's hand with the pose associated with the particular type of user interface element, as indicated in the tutorial data. Additionally, the processor 125 compares a transformation of the novice user's hand with an expected transformation of the hand for performing the particular operation, the expected transformation being stored in the tutorial data.

The method 1200 continues with outputting perceptible feedback depending on whether the person correctly interacted with the particular physical user interface element to perform the first operation (block 1240). Particularly, the processor 125 outputs, with an output device, perceptible feedback depending on whether novice user correctly interacts with the particular type of user interface element to correctly perform the particular operation. The perceptible feedback may take a variety of forms, including AR graphical elements or visualizations displayed in the AR graphical user interface, sounds output by a speaker of the AR system 120, or vibrations output by the haptics 131 of the hand wearable controller 122.

The perceptible feedback may take the form of an affirmative notification that indicates that a step of the task was performed correctly. Particularly, in one embodiment, the processor 125 outputs, with an output device, perceptible feedback in response to the novice user correctly interacting with the particular type of user interface element indicated in the tutorial data to correctly perform the particular operation indicated in the tutorial data.

In addition, the perceptible feedback may take the form of a warning or error that indicates that a step of the task was not performed correctly. Particularly, in one embodiment, the processor 125 outputs, with an output device, perceptible feedback in response to the novice user interacting with a type of physical user interface element other than the type of user interface element indicated in the tutorial data. Additionally, in one embodiment, the processor 125 outputs, with an output device, perceptible feedback in response to the novice user correctly interacting with the particular type of user interface element indicated in the tutorial data but incorrectly performing an operation other than the particular operation indicated in the tutorial data.

Finally, the perceptible feedback may take the form of a preemptive warning or error that indicates that the user may be about to perform a step of the task incorrectly. Particularly, in one embodiment, the processor 125 outputs, with an output device, perceptible feedback preemptively in response to the novice user touching, but not yet operating, a type of physical user interface element other than the type of user interface element indicated in the tutorial data. Additionally, in one embodiment, the processor 125 outputs, with an output device, perceptible feedback preemptively in response to the novice user correctly interacting with the particular type of user interface element indicated in the tutorial data, but starting to perform an operation other than the particular operation indicated in the tutorial data (e.g., turning a knob in the wrong direction).

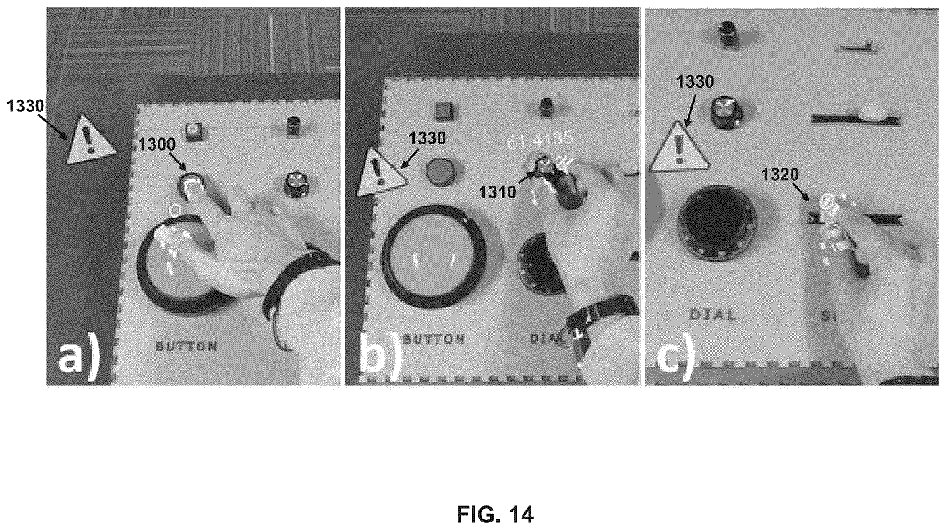

FIG. 14 shows how a preemptive warning is provided when providing an AR tutorial. This is especially helpful when users would have to start over from several steps back due to an incorrect operation, which is a frustrating experience. Particularly, there are two classes of errors. First, the novice user may locate the wrong user interface elements, such as pressing a wrong button 1300 as shown in illustration a) of FIG. 14. Second, the novice user may operate a user interface element in the wrong way, such as turning a knob 1310 in the wrong direction, as shown in illustration b) of FIG. 14, or pushing a slider 1320 in the wrong direction, as shown in illustration c) of FIG. 14. Based on the types of errors, the preemptive feedback is provided in three stages.

Firstly, the processor 125 retrieves the finger's location when it receives a half press signal indicating the finger is touching the user interface element. If the position is not aligned with where the authored operation took place (the first class of error), the processor 125 immediately outputs a preemptive warning. In one embodiment, the preemptive warning includes both a vibration from the haptics 131 of the hand wearable controller 122, as well as a virtual warning sign 1330 shown in the AR graphical user interface. Second, the processor 125 predicts the fingers' intended movement direction by comparing the pressure signals from IndexTip and ThumbTip respectively or by observing a rotation of a hand pose. For knob and swipe operation, the processor 125 outputs a preemptive warning as soon as the user starts rotating/swiping in the wrong way (the second class of error). Third, when the user removes his finger from the incorrect user interface element or corrects the direction of operation (e.g., immediately turning the knob reversely), the processor 125 causes the preemptive warning to disappear or otherwise cease.

The processor 125 advantageously incorporates an error handling mechanism in the event that the user performs the incorrect operation despite the warnings. After each operation is performed, the processor 125 detects the operation and compares it with the pre-authored operation to determine if an error has been made. Due to the offset during gesture tracking, it is anticipated that continuous gestures (e.g., pushing a slider, turning a knob) tracked in real-time cannot precisely match the pre-recorded ones, even if the operation is performed correctly. Thus, the processor 125 allows for a predetermined percent margin of error (e.g., 20% margin of error) when comparing the trajectories of continuous operations. In at least some embodiments, pausing and forwarding of an AR tutorial's playback are automated by the processor 125. If an error has been detected, the AR tutorial will pause. Users may resume it manually if they believe that the incorrect operation does not have any negative consequences, or they may choose to restart the current step or the entire task if they believe otherwise. If no error is detected, the processor 125 will automatically advance to the subsequent step (i.e., display the appropriate graphical elements for the next step).

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for authoring an augmented reality tutorial for operating a device, the method comprising:
recording, with at least one sensor, interactions of a person with physical user interface elements of the device as the person demonstrates a first operation of the device;
determining, with a processor, based on the recorded interactions, (i) a first type of physical user interface element that was interacted with, (ii) a first location on the device at which the first type of physical user interface element was interacted with, and (iii) the first operation that was performed; and
displaying, on a display in an augmented reality graphical user interface, graphical tutorial elements including a first graphical tutorial element superimposed at the first location on the device and indicating the first type of physical user interface element that was interacted with and the first operation that was performed.

2. The method according to claim 1, the recording further comprising:
measuring, with at least one hand-worn sensor, pressures applied with individual fingers of a hand of the person; and
capturing, with a camera, images of the hand of the person.

3. The method according to claim 2, the determining further comprising:
determining a location of the hand based on the images; and
detecting that the first type of physical user interface element was interacted with in response to a pressure being applied with at least one finger of the hand while the hand is located in a defined region associated with the device.

4. The method according to claim 3 further comprising:
defining, with the processor, prior to the recording, based on user inputs, the defined region associated with the device.

5. The method according to claim 3, the determining further comprising:
detecting that the first type of physical user interface element was interacted with in response to pressures being applied with a predetermined number of fingers of the hand while the hand is located in the defined region associated with the device.

6. The method according to claim 3, the determining further comprising:
determining a pose of the hand based on the images; and
detecting that the first type of physical user interface element was interacted with in response to a pressure being applied with at least one finger of the hand while the hand is located in the defined region associated with the device and while the hand has a defined pose associated with the first type of physical user interface element.

7. The method according to claim 3, the determining further comprising:
determining a transformation of the hand based on the images; and
determining the first operation that was performed based on the transformation of the hand while the pressure is applied with the at least one finger of the hand and while the hand is located in a defined region associated with the device.

8. The method according to claim 1, the displaying the graphical tutorial elements further comprising:
displaying, on the display in the augmented reality graphical user interface, a virtual arrow that is oriented to point toward the first location on the device.

9. The method according to claim 1, the displaying the graphical tutorial elements further comprising:
displaying, on the display in the augmented reality graphical user interface, a virtual arrow that is superimposed at or adjacent to the first location on the device and is oriented to point toward a direction in which the first type of physical user interface element must be manipulated to perform the first operation.

10. The method according to claim 9, the displaying the graphical tutorial elements further comprising:
displaying the virtual arrow with a length that is proportional to a magnitude of an adjustment that must be made to perform the first operation.

11. The method according to claim 9, the displaying the graphical tutorial elements further comprising:
displaying, on the display in the augmented reality graphical user interface, virtual text adjacent to the virtual arrow that indicates a magnitude of an adjustment that must be made to perform the first operation.

12. The method according to claim 9, the displaying the graphical tutorial elements further comprising:
displaying the virtual arrow with a size that is proportional to a size of a physical user interface element of the physical user interface elements that was interacted with.

13. The method according to claim 1, the displaying the graphical tutorial elements further comprising:
recording, with a microphone, natural language speech from the person;
transcribing, with the processor, the natural language speech into text; and
displaying, on the display in the augmented reality graphical user interface, the text superimposed on or adjacent to the device.

14. The method according to claim 1, wherein:
the recording further comprising capturing, with a camera, an image of the device after the person demonstrates the first operation; and
the displaying further comprising displaying, on the display in the augmented reality graphical user interface, the image of the device after the person demonstrated the first operation.

15. A method for providing an augmented reality tutorial for operating a device, the method comprising:
storing, in a memory, tutorial data indicating (i) a first type of physical user interface element that is to be interacted with, (ii) a first location on the device at which the first type of physical user interface element is to be interacted with, and (iii) a first operation that is to be performed;
displaying, on a display in an augmented reality graphical user interface, graphical tutorial elements including a first graphical tutorial element superimposed at the first location on the device and indicating the first type of physical user interface element that is to be interacted with and the first operation that is to be performed;
recording, with at least one sensor, interactions of a person with physical user interface elements of the device; and
determining, with a processor, based on the recorded interactions, (i) whether the person has interacted with the first type of physical user interface element at the first location on the device and (ii) whether the person has performed the first operation.

16. The method according to claim 15 further comprising:
outputting, with an output device, first perceptible feedback in response to the person correctly interacting with the first type of physical user interface element to perform the first operation.

17. The method according to claim 15 further comprising:
outputting, with an output device, second perceptible feedback in response to the person interacting with a type of physical user interface element other than the first type of physical user interface element.

18. The method according to claim 17, wherein the second perceptible feedback is output immediately in response to the person touching the type of physical user interface element other than the first type of physical user interface element.

19. The method according to claim 15 further comprising:
outputting, with an output device, second perceptible feedback in response to the person interacting with the first type of physical user interface element and performing an operation other than the first operation.

20. The method according to claim 19, wherein:
the recording further comprises capturing, with a camera, images of the hand of the person; and
the determining further comprises (i) determining a transformation of the hand based on the images and (ii) comparing the transformation with an expected transformation of the hand for performing the first operation, the expected transformation being stored in the tutorial data.
